(19) United States
(12) Patent Application Publication
(10) Pub. No.: US 2016/0377247 A1
(43) Pub. Date: Dec. 29, 2016

(54) SOLAR POWERED ILLUMINATION DEVICE

(71) Applicant: Kuei-Hsiang CHANG, Antioch, CA (US)

(72) Inventor: Kuei-Hsiang CHANG, Antioch, CA (US)

(21) Appl. No.: 15/191,579

(22) Filed: Jun. 24, 2016

(30) Foreign Application Priority Data
Jun. 24, 2015 (CN) 201510352456.9
Jun. 24, 2015 (CN) 201520436617.8
Jun. 24, 2015 (CN) 201520436676.5
Jun. 24, 2015 (CN) 201520436712.8
Jun. 24, 2015 (CN) 201520436738.2
Jun. 24, 2015 (CN) 201520436741.4

(51) Int. Cl. F21S 9/03; F21V 3/00; F21V 31/00

(52) U.S. Cl. CPC F21S 9/037; F21V 31/005; F21V 3/00; F21W 2131/10

(57) ABSTRACT

A solar powered illumination device comprises solar panels arranged on a flexible holder, which is arranged on an upper surface of a support. A lower housing comprises an outer circumferential wall and an inner circumferential wall, wherein a drain hole is formed between the outer circumferential wall and the inner circumferential wall. A waterproof gasket is arranged between a lower surface of the support and the inner circumferential wall of the lower housing. As the flexible holder is secured on the support, the solar panels are prevented from being shaken or moved arbitrarily due to drastic shaking and therefore the energy conversion efficiency of the solar panels is retained. By means of the lower surface of the support, the waterproof gasket, the inner circumferential wall and the drain hole, a good water resistance can be obtained.

### CROSS-REFERENCE TO RELATED APPLICATIONS

This application is a continuation-in-part of application Ser. No. 13/674,838 filed on Nov. 12, 2012, now pending, which is incorporated by reference herein in its entirety. This application also claims priority under 35 U.S.C. §119 to Chinese Patent Application No. 201510352456.9 filed Jun. 24, 2015; Chinese Utility Model Application No. 201520436676.5 filed on Jun. 24, 2015; Chinese Utility Model Application No. 201520436712.8 filed on Jun. 24, 2015; Chinese Utility Model Application No. 201520436738.2 filed on Jun. 24, 2015; Chinese Utility Model Application No. 201520436741.4 filed on Jun. 24, 2015; and Chinese Utility Model Application No. 201520436617.8 filed on Jun. 24, 2015, which are incorporated by reference herein in their entirety.

### FIELD OF THE INVENTION

The invention relates a solar powered illumination device, particularly to a decorative lamp to be used in a courtyard, outdoor site or indoor site.

### DESCRIPTIONS OF THE RELATED ART

Usually, a conventional horticultural or decorative illumination device powered by solar energy has a plurality of solar panels arranged outside a lamp cover. However, such an illumination device has problems that it has a larger volume and is less aesthetic and that the solar panels which are exposed may be damaged due to weather or be damaged by the human intentionally or unintentionally.

In US Patent Publication No. US2014/0133138 A1, entitled “Illuminating Device Having Folding Solar Panels”, which was invented by the same inventor of this application, an illuminating device having two solar panels installed on a folding holder is disclosed, wherein the folding holder is put into a lamp cover in a folded state and then unfolded by pulling wires connected to the solar panels so that the solar panels have better energy conversion efficiency. Accordingly, an overall volume of the illumination device may be reduced. The quantity of acquired sunlight is increased because the solar panels are arranged on the top portion of the product and not shielded from the sun.

However, the folding holder is not firmly retained in the illuminating device as disclosed in US2014/0133138A1, so that the folding holder has a tendency to loosen after a long-term use. In the long run, as the two solar panels cannot be kept horizontal, the energy conversion efficiency of the solar panels would be disadvantageously influenced. If the folding holder is overly loosened, the solar panels may be damaged due to impact, or broken due to swing of wires when a lamp is under drastic movement. The conventional illuminating device as disclosed in US2014/0133138A1 has a poor water resistance, and draining water from a lower housing may be difficult.

### SUMMARY OF THE INVENTION

The major object of the invention is to provide a solar powered illumination device in order to reduce an overall volume of a lamp significantly, increase reliability, maintain better energy conversion efficiency, and improve water resistance.

In order to achieve the above objects, a solar powered illumination device according to the invention comprises a hollow lamp cover, a light source, at least two solar panels, a flexible holder, a support, a control circuit board, a waterproof gasket and a lower housing, wherein the hollow lamp cover comprises an opening, and the at least two solar panels are arranged on the flexible holder, which is arranged on an upper surface of the support. In addition, the control circuit board is arranged on the lower surface of the support with the at least two solar panels being electrically connected to the control circuit board. The lower housing comprises an outer circumferential wall and an inner circumferential wall, and the outer circumferential wall is spaced from the inner circumferential wall with a drain hole provided between the two walls. The support is arranged on the lower housing, and the waterproof gasket is arranged between a lower surface of the support and the inner circumferential wall of the lower housing. The hollow lamp cover is installed in the lower housing in such a manner that the flexible holder is folded at a specific angle and then passes through the opening of the hollow lamp cover.

According to the invention, the flexible holder is fitted on the upper surface of the support firmly so that the solar panels will not be shaken or moved arbitrarily, and hence the energy conversion efficiency is not affected. The wires connected to the solar panels will not be damaged by drastic shaking. With the aid of the configuration having the lower surface of the support, the waterproof gasket, and the inner circumferential wall of the lower housing, a good water resistance is available. In addition, with the arrangement of the drain hole, even though water enters into the lower housing, water can be drained.

Further, the support has a lower surface which is provided with an annular groove, the waterproof gasket is arranged in the annular groove, and the inner circumferential wall is abutted on the waterproof gasket in the annular groove of the support.

Still Further, the waterproof gasket has a U-shaped cross-section which is fit to the inner circumferential wall of the lower housing.

Preferably, the invention further comprises a retaining plate which is arranged between the upper surface of the support and the flexible holder. The retaining plate comprises at least two spring-loaded supporting brackets extend outward of the retaining plate, wherein when the hollow lamp cover is installed in the lower housing, the at least two spring-loaded supporting brackets is abut against an inner wall surface of the hollow lamp cover. Accordingly, the light source and the flexible holder are retained in the lamp cover by the retaining plate.

Furthermore, the flexible holder of the invention comprises a central through hole, the retaining plate comprises a central opening, and a central sleeve comprising a passage is formed on the upper surface of the support, in which the central sleeve is fitted into the central opening of the retaining plate, the light source and the at least two solar panels are electrically connected with the control circuit board arranged on the lower surface of the support through the central through hole and the passage. In other words, the wires for connecting the light source and the at least two solar panels pass through the central through hole and the passage, and are electrically connected with the control circuit board on the lower surface of the support.

In addition, according to the invention, at least one stud may be formed on the upper surface of the support, and at least one support sleeve may be formed on a lower surface of the flexible holder, wherein the at least one support sleeve has an inner diameter greater than an outer diameter of the at least one stud, and the at least one stud is fitted into the at least one support sleeve. Accordingly, the support sleeve and the stud may serve to locate and retain the flexible holder. Since each of the support sleeve and the stud has a certain height, the flexible holder can be positioned at a higher level so that the flexible holder is spaced from the support and the retaining plate by a certain distance. Therefore, the spring-loaded supporting brackets would not interfere with the flexible holder so that the flexible holder can be unfolded sufficiently and the effective sunlight receiving area of the at least two solar panels may be not reduced.

Preferably, at least one upright sleeve may be formed on an inner bottom surface of the lower housing, and at least one retaining post may be formed on the lower surface of the support, wherein the at least one upright sleeve has an inner diameter greater than an outer diameter of the at least one retaining post, and the at least one retaining post is fitted into the at least one upright sleeve. Moreover, the at least one upright sleeve may comprise a hollow portion in which an inner shoulder may be provided, and a lower end face of the at least one retaining post may be abutted on the inner shoulder. Accordingly, the retaining post and the upright sleeve may serve to locate and retain the support. Since the upright sleeve is provided with the inner shoulder, the position and height of the support with respect to the lower housing can be kept.

Further, a slot may be formed on an inner bottom surface of the lower housing, and the control circuit board may comprise a switch a part of which is extended out of the lower housing through the slot. Accordingly, the switch of the invention may be arranged on a bottom surface of the lower housing so as to avoid impact on the whole aesthetic appearance due to the switch and prevent water from entering into the lower housing.

Moreover, the control circuit board of the invention may be arranged on the lower surface of the support in such a manner that the control circuit board is vertical to the lower surface of the support, and the switch may comprise an operating element a part of which may be extended out of the lower housing through the slot. Accordingly, the mechanisms or electronic elements may be arranged in the lower housing compactly, and assemblage becomes convenient. Preferably, the invention may further comprise a battery module arranged on the lower surface of the support and electrically connected with the control circuit board.

Moreover, the invention may further comprise two conductive metal straps arranged on the lower surface of the support, each of the two conductive metal straps having one end electrically connected with the control circuit board and the other end electrically connected with the battery module. Accordingly, the invention may reduce soldering points and facilitate assemblage, and hence cost may be reduced effectively.

### BRIEF DESCRIPTION OF THE DRAWINGS

FIG. 1 is an exploded view showing a solar powered illumination device of a first embodiment of the present invention.

FIG. 2 is a perspective view showing the solar powered illumination device of the first embodiment of the present invention after removing a hollow lamp.

FIG. 3 is an exploded view showing a support and a lower housing of the solar powered illumination device of the first embodiment.

FIG. 4 is a sectional view showing a flexible holder, a retaining plate, a support and a control circuit board of the solar powered illumination device of the first embodiment.

FIG. 5 is a sectional view showing the solar powered illumination device of the first embodiment of the present invention.

FIG. 6 is an exploded view showing a support and a lower housing of a solar powered illumination device of a second embodiment.

FIG. 7 is a bottom view showing a flexible holder, a retaining plate, a support and a control circuit board of the solar powered illumination device of the second embodiment.

FIG. 8 is a sectional view showing the solar powered illumination device of the second embodiment of the present invention.

FIG. 9 is a sectional view showing the solar powered illumination device of a third embodiment of the present invention.

### DETAILED DESCRIPTION OF THE PREFERRED EMBODIMENT

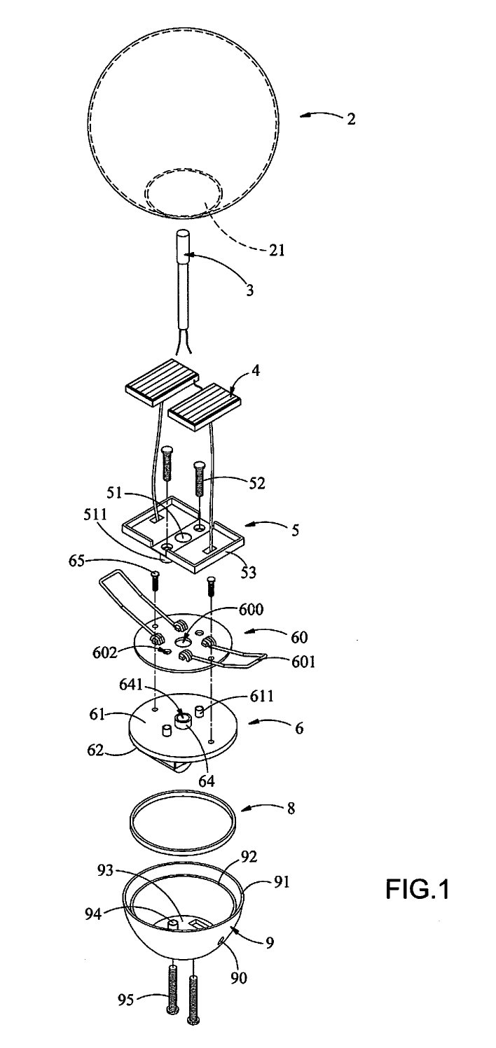

In describing the preferred embodiments of the present invention, reference will be made herein to FIGS. 1-8 of the drawings in which like numbers refer to like features of the invention. The drawings are made schematically for illustrative purpose and not drawn to scale. A part of the details of the lamp may be not shown in the drawings.

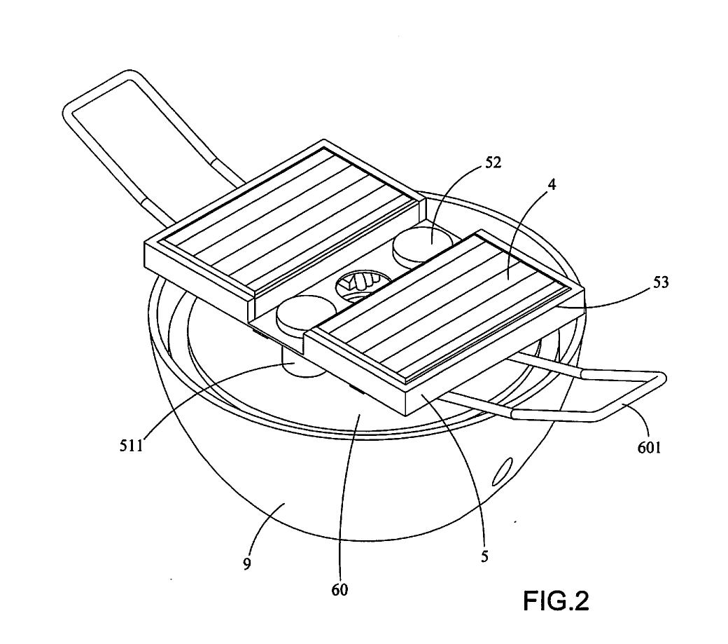

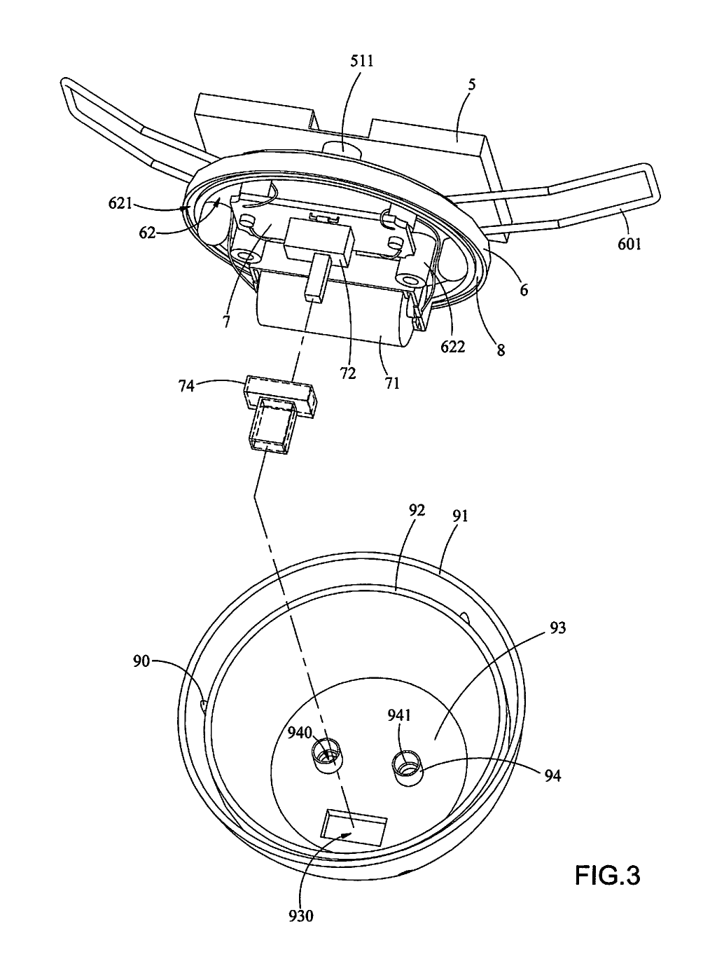

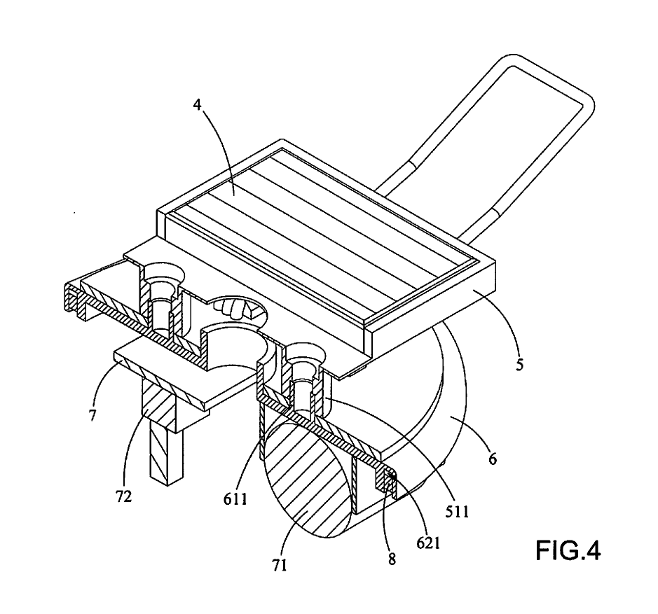

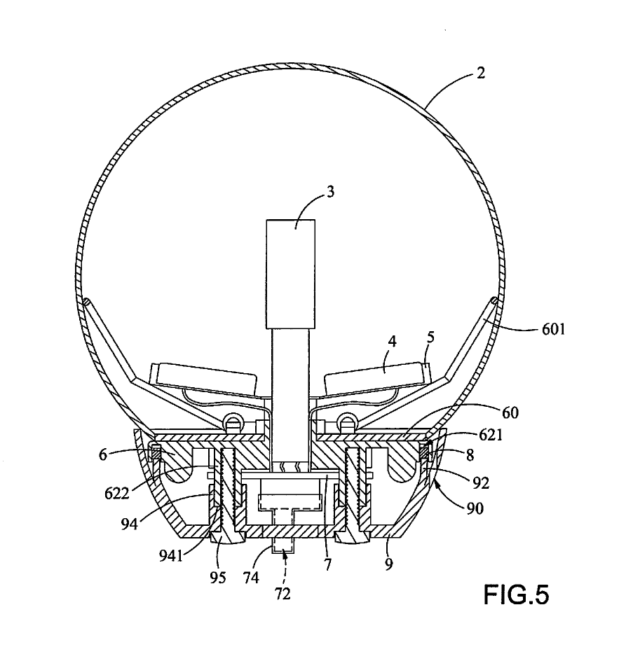

Reference is made to FIGS. 1 to 5, wherein FIG. 1 is an exploded view showing a solar powered illumination device of a first embodiment of the present invention, FIG. 2 is a perspective view showing the solar powered illumination device of the first embodiment of the present invention after removing a hollow lamp cover, FIG. 3 is an exploded view showing a support and a lower housing of the solar powered illumination device of the first embodiment, FIG. 4 is a sectional view showing a flexible holder, a retaining plate, a support and a control circuit board of the solar powered illumination device of the first embodiment, and FIG. 5 is a sectional view showing the solar powered illumination device of the first embodiment of the present invention.

As shown in the figures, the solar powered illumination device of the first embodiment comprises a hollow lamp cover 2, a light source 3, two solar panels 4, a flexible holder 5, a retaining plate 60, a support 6, a control circuit board 7, a battery module 71, a waterproof gasket 8 and a lower housing 9. The hollow lamp cover 2 comprises an opening 21. The flexible holder 5 comprises two carriers 53 for carrying the two solar panels 4, respectively, wherein a portion connecting the two carriers 53 is flexible. A central through hole is provided between the two carriers 53 of the flexible holder 5, and two support sleeves 511 are formed on a lower surface of the flexible holder 5.

In addition, the retaining plate 60 is arranged under the flexible holder 5 and is provided with two spring-loaded supporting brackets 601 extending outward from the retaining plate 60. The retaining plate 60 is formed with a central opening 600 and two bores 602. On the other hand, a central sleeve 64 and two studs 611 are formed on an upper surface 61 of the support 6, wherein the central sleeve 64 comprises a passage 641 corresponding to the central opening 600 of the retaining plate 60 and the central through hole 51 of the flexible holder 5. The central sleeve 64 and the studs 611 of the support 6 are fitted into the central opening 600 and the two bores 602 of the retaining plate 60, respectively. Also, the support sleeve 511 has an inner diameter larger than an outer diameter of the stud 611, so that the two studs 611 can be fitted into the two support sleeves 511, respectively. As shown in the figures, the retaining plate 60 is secured on the upper surface 61 of the support 6 by two screws 65, and the flexible holder 5 is secured on the support 6 by two additional screws 52 which extend through the two support sleeves 511 and then are screwed onto the two studs 611.

Accordingly, the support sleeve 511 and the studs 611 in the first embodiment may serve to locate and retain the flexible holder 5. Since each of the support sleeve 511 and the studs 611 has a certain height, the flexible holder 5 can be positioned at a higher level so that the flexible holder 5 is spaced from the support 6 and the retaining plate 60 by a certain distance. Therefore, the spring-loaded supporting brackets 601 would not interfere with the flexible holder 5 so that the flexible holder 5 can be unfolded sufficiently and the effective sunlight receiving area of the two solar panels 4 may be not reduced.

As shown in FIGS. 3 and 4, an annular groove 621 is circumferentially formed on a lower surface 62 of the support 6, and the waterproof gasket 8 is disposed in the annular groove 621. In addition, the control circuit board 7 and the battery module 71 are also arranged on the lower surface 62 of the support 6. In the first embodiment, the control circuit board 7 is laid on the lower surface 62 of the support 6, and the control circuit board 7 comprises a switch facing downwards. In addition, the light source 3 and the solar panels 4 are electrically connected with the control circuit board 7 located on the lower surface 62 of the support 6 by conductive wires extending through the central through hole 51 and the passage 641, and the battery module 71 is electrically connected with the control circuit board 7 by conductive wires.

Still, as shown in FIGS. 3 and 5, two retaining posts 622 are formed on the lower surface 62 of the support 6. The lower housing 9 comprises an outer circumferential wall 91 and an inner circumferential wall 92. Three drain holes 90 are equidistantly formed between the outer circumferential wall 91 and the inner circumferential wall 92. Two upright sleeves 94 and a slot 930 are formed on an inner bottom surface 93 of the lower housing 9. An inner diameter of the upright sleeve 94 is greater than an outer diameter of the retaining post 622, so that the retaining posts 622 may be fitted into the upright sleeves 94. The upright sleeve 94 comprises a hollow portion 940 provided with an inner shoulder 941 therein, and a lower end face of the retaining post 622 is abutted on the inner shoulder 941, thereby the position and height of the support 6 with respect to the lower housing 9 are kept.

As shown in FIG. 5, the support 6 is secured on the lower housing 9 by two long screws 95 which extend through the hollow portions 940 of the upright sleeves 94 and are screwed onto the two retaining posts 622, respectively. As the inner circumferential wall 92 is abutted on the waterproof gasket 8 in the annular groove 621 of the support 6, a drain path is formed between the outer circumferential wall 91 and the inner circumferential wall 92. If water flows into the lower housing 9 along the hollow lamp cover 2, the water would flow into the space between the outer circumferential wall 91 and the inner circumferential wall 92 and be drained out through the drain holes 90. As such, the water is prevented from permeating through the inner circumferential wall 92, and the internal circuits are protected from the water.

On the other hand, as shown in FIGS. 3 and 5, a part of the switch 72 on the control circuit board 7 extends out of the lower housing 9 through the slot 930. The solar powered illumination device of the first embodiment further comprises a waterproof cover 74 for covering the part of the switch 72. As such, water or moisture can be prevented from entering into the lower housing 9 through a gap between the switch 72 and the slot 930, and the switch 72 is isolated from water or moisture.

How to assembling the lamp is described below. The solar panels 4 are installed on the carriers 53 of the flexible holder 5. The control circuit board 7, the battery module 71 and the waterproof gasket 8 are installed on the support 6. The retaining plate 60 is mounted on the upper surface 61 of the support 6, and then the flexible holder 5 is placed above the retaining plate 60 and secured on the support 6. The light source 3, the solar panels 4, the control circuit board 7 and the battery module 71 are electrically connected with each other. Then, the support 6 is mounted on the lower housing 9.

The hollow lamp cover 2 is assembled on the lower housing 9 by bending the two spring-loaded supporting brackets 601 together with the flexible holder 5 to a specific angle and then passing the same through the opening 21 of the hollow lamp cover 2. After the two spring-loaded supporting brackets 601 with the flexible holder 5 pass through the opening 21 of the hollow lamp cover 2, the two spring-loaded supporting brackets 601 spring back due to the elastic force with the ends of two spring-loaded supporting brackets 601 being abutted on an inner wall surface of the hollow lamp cover 2 so that the flexible holder 5 is unfolded, and the light source 3 and the flexible holder 5 are held within the hollow lamp cover 2.

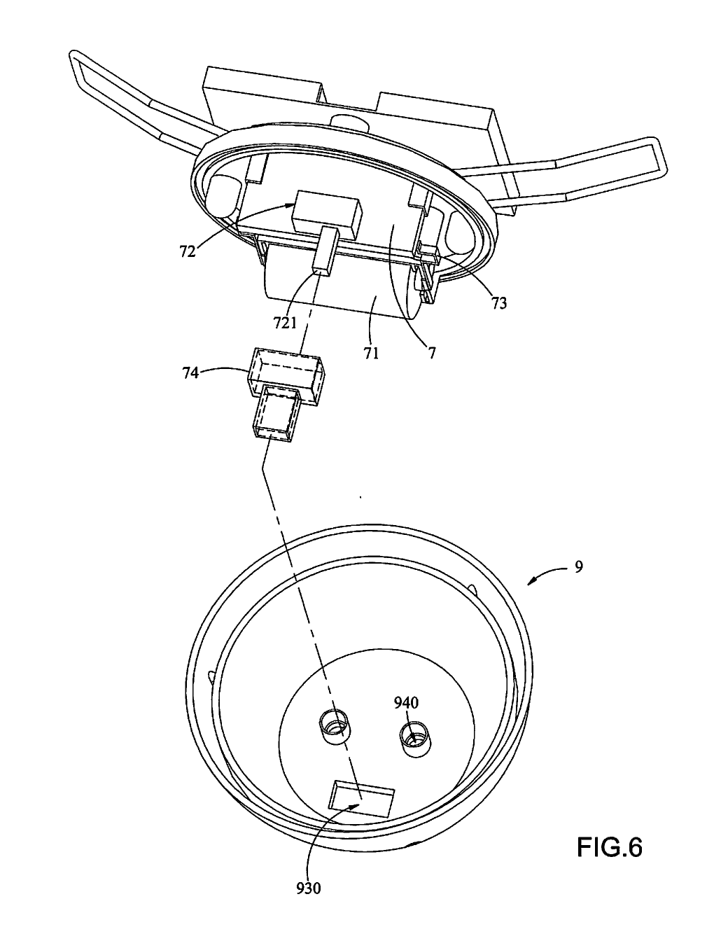

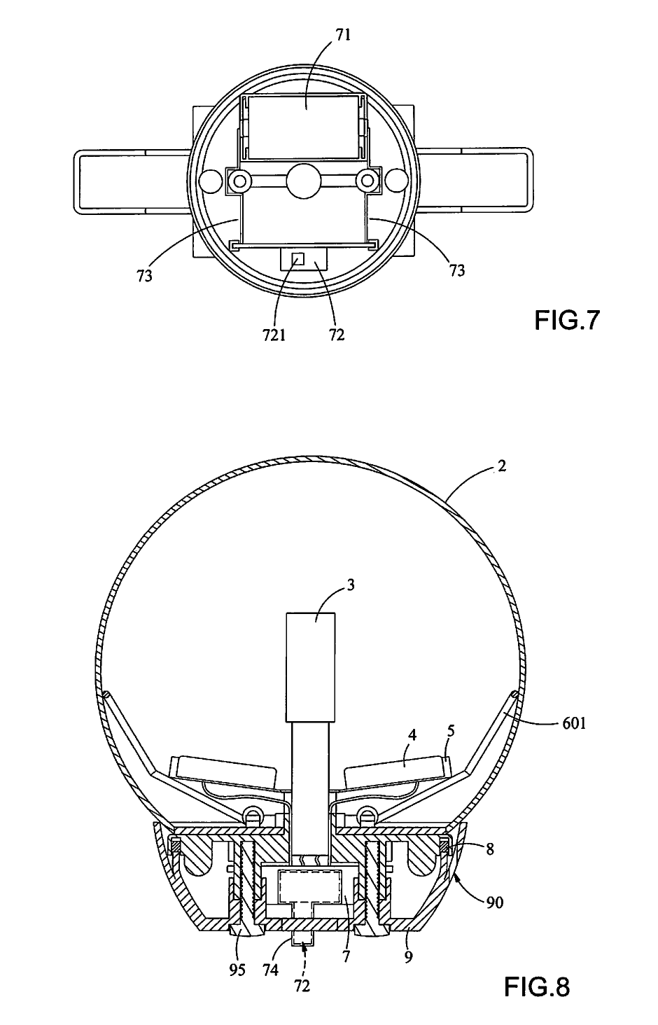

Referring to FIGS. 6, 7 and 8, FIG. 6 is an exploded view showing a support and a lower housing of a solar powered illumination device of a second embodiment. FIG. 7 is a bottom view showing a flexible holder, a retaining plate, the support and a control circuit board of the solar powered illumination device of the second embodiment. FIG. 8 is a sectional view showing the solar powered illumination device of the second embodiment of the present invention. As shown in the figures, the second embodiment differs from the first embodiment in that in the second embodiment, the control circuit board 7 is vertically positioned, and instead of the conductive wires, conductive metal straps 73 are used and connected to the battery module 71.

In the second embodiment, the control circuit board 7 is arranged on and vertical to the lower surface 62 of the support 6. The switch 72 is L-shaped, and the side where electrical contacts are arranged is perpendicular to the side where an operating element 721 is arranged. The electrical contacts of the switch 72 are soldered on the vertical control circuit board 7. The operating element 721 extends downwards, and a part of the operating element 721 is protruded out of the lower housing 9 through the slot 930. Accordingly, the mechanisms or electronic elements may be arranged in the lower housing 9 compactly. Instead of the conventional conductive wires, the two conductive metal straps 73 are used in such a manner that each conductive metal strap 73 has one end electrically connected with the control circuit board 7 and the other end electrically connected with the battery module 71. Accordingly, soldering operation may be reduced, reliability may be improved, assemblage may be further convenient, and cost may be reduced.

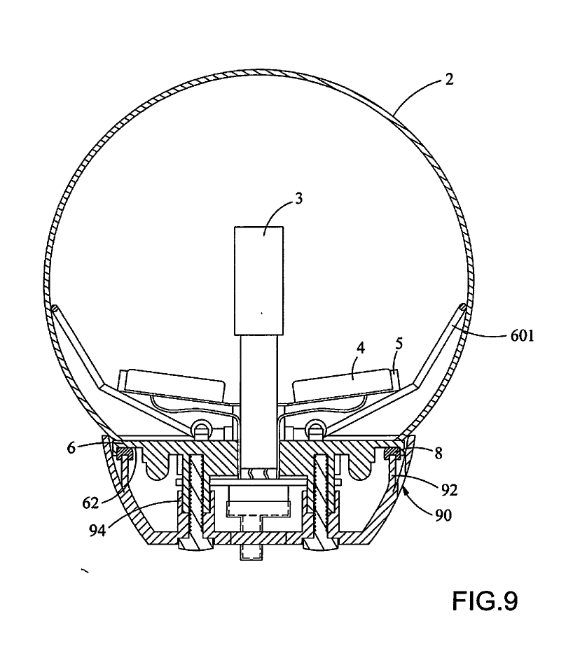

Referring to FIG. 9, FIG. 9 is a sectional view showing the solar powered illumination device of the third embodiment of the present invention. As shown in the figure, the third embodiment differs from the first embodiment in that in the third embodiment, the waterproof gasket 81 has an U-shaped cross-section which is fit to the inner circumferential wall 92 of the lower housing 9. In other words, the waterproof gasket 81 with a U-shaped cross-section can be installed on the inner circumferential wall 92 of the lower housing 9 directly, and the annular groove 621 can be omitted.

While this invention has been described in reference to the preferred embodiments, it should be understood that numerous changes could be made within the spirit and scope of the inventive concepts described. Accordingly, it is intended that the invention not be limited to the disclosed embodiments, but that is have the full scope permitted by the language of the following claims.

What is claimed is:

1. A solar powered illumination device comprising:
a hollow lamp cover having an opening;
a light source;
at least two solar panels;
a flexible holder on which the at least two solar panels are arranged;
a support having an upper surface on which the flexible holder is arranged;
a control circuit board arranged on the lower surface of the support and electrically connected with the light source and the at least two solar panels;
a lower housing comprising an outer circumferential wall and an inner circumferential wall, the outer circumferential wall being spaced from the inner circumferential wall and provided with a drain hole between the outer circumferential wall and the inner circumferential wall, the support being arranged on the lower housing; and
a waterproof gasket arranged between a lower surface of the support and the inner circumferential wall of the lower housing;
wherein the hollow lamp cover is installed in the lower housing in such a manner that the flexible holder is folded and put into the hollow lamp cover through the opening of the hollow lamp cover and that an outer wall surface of the hollow lamp cover is abutted on the outer circumferential wall of the lower housing.

2. The solar powered illumination device of claim 1, wherein the support further has a lower surface which is provided with an annular groove, the waterproof gasket is arranged in the annular groove, and the inner circumferential wall is abutted on the waterproof gasket in the annular groove of the support.

3. The solar powered illumination device of claim 1, wherein the waterproof gasket having a U-shaped cross-section which is fit to the inner circumferential wall of the lower housing.

4. The solar powered illumination device of claim 1, further comprising a retaining plate which is arranged between the support and the flexible holder, the retaining plate comprising at least two spring-loaded supporting brackets extending outward from the retaining plate, wherein when the hollow lamp cover is installed in the lower housing in such a manner that the at least two spring-loaded supporting brackets and the flexible holder are folded and put into the hollow lamp cover through the opening of the hollow lamp cover, the at least two spring-loaded supporting brackets spring back and are abutted on an inner wall surface of the hollow lamp cover.

5. The solar powered illumination device of claim 4, wherein the flexible holder comprises a central through hole, the retaining plate comprises a central opening, and a central sleeve with a passage is formed on the upper surface of the support, in which the central sleeve is fitted into the central opening of the retaining plate, the light source and the at least two solar panels are electrically connected with the control circuit board arranged on the lower surface of the support by electrically conductive elements extending through the central through hole and the passage.

6. The solar powered illumination device of claim 1, wherein at least one stud is formed on the upper surface of the support, and at least one support sleeve is formed on a lower surface of the flexible holder, in which the at least one support sleeve has an inner diameter greater than an outer diameter of the at least one stud, and the at least one stud is fitted into the at least one support sleeve.

7. The solar powered illumination device of claim 1, wherein at least one upright sleeve is formed on an inner bottom surface of the lower housing, and at least one retaining post is formed on the lower surface of the support, in which the at least one upright sleeve has an inner diameter greater than an outer diameter of the at least one retaining post, and the at least one retaining post is fitted into the at least one upright sleeve.

8. The solar powered illumination device of claim 7, wherein the at least one upright sleeve comprises a longitudinal hollow portion in which an inner shoulder is provided, and a lower end face of the at least one retaining post is abutted on the inner shoulder.

9. The solar powered illumination device of claim 1, wherein a slot is formed on an inner bottom surface of the lower housing, and the control circuit board comprises a switch a part of which is extended out of the lower housing through the slot.

10. The solar powered illumination device of claim 9, wherein the control circuit board is arranged on the lower surface of the support in such a manner that the control circuit board is vertical to the lower surface of the support, and the switch comprises an operating element a part of which is extended out of the lower housing through the slot.

11. The solar powered illumination device of claim 10, further comprising a battery module arranged on the lower surface of the support and electrically connected with the control circuit board.

12. The solar powered illumination device of claim 11, further comprising two conductive metal straps arranged on the lower surface of the support, each of the two conductive metal straps having one end electrically connected with the control circuit board and the other end electrically connected with the battery module.
